(19) United States
(12) Patent Application Publication
(10) Pub. No.: US 2010/0103428 A1
(43) Pub. Date: Apr. 29, 2010

(54) SIGNAL LIGHT GENERATING APPARATUS USING OPTICAL FIBER AND ROTATION SENSING APPARATUS

(76) Inventors: Young-soon HEO, Gwangju-si (KR); Chong-hee YU, Gwangju-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/487,586

(22) Filed: Jun. 18, 2009

(30) Foreign Application Priority Data
Oct. 29, 2008 (KR) 10-2008-0106515

(51) Int. Cl. G01C 19/72; H01S 3/13

(52) U.S. Cl. 356/460; 372/32

(57) ABSTRACT

A light signal generating apparatus including an erbium-doped optical fiber is provided. The signal light generating apparatus includes a optical fiber which is a gain medium, a light source to emit pump light, a stabilizing unit to compensate for changes of a mean wavelength of the signal light with respect to temperature change in the optical fiber to thereby stabilize the mean wavelength of the signal light, and an optical coupler to transmit the pump light from the light source to the optical fiber and to output signal light returning from the optical fiber and signal light returning from the optical fiber via the stabilizing unit by which the single light is stabilized. Accordingly, the apparatus can lower the change of the mean wavelength with respect to temperature and lower a pump power required of the pump light source.

### CROSS REFERENCE TO RELATED APPLICATION

This application claims the benefit under 35 U.S.C. §119(a) of Korean Patent Application No. 10-2008-106515, filed on Oct. 29, 2008, the disclosure of which is incorporated herein in its entirety by reference.

### BACKGROUND

1. Field

The following description relates to a configuration of a signal light generating apparatus, and more particularly, to a configuration of a signal light generating apparatus including an erbium-doped optical fiber.

2. Description of the Related Art

An optical fiber gyroscope generally includes a Sagnac loop formed of a coiled optical fiber, a light source, and a signal processing unit. Light emitted from the light source is incident to the optical fiber Sagnac loop, and a rotation rate is measured based on a phase difference between clockwise-rotating light and counter-clockwise rotating light, that is, the Sagnac phase difference.

To measure an accurate rotation speed from the Sagnac phase difference obtained by the optical fiber gyroscope, highly stabilized scale factors are required. From among parameters that determine the scale factors, an area surrounded by a coil is relatively stable against external perturbation. In addition, a mean wavelength of light emitted from the light source needs to be stable for more stable scale factors. Thus, the gyro light source of the optical gyroscope should have a notably stable mean wavelength in order to achieve high measurement accuracy.

A semiconductor light source utilizing a single-pass backward (SPB) arrangement which is generally used as a gyro light source has a mean wavelength variation of several hundreds ppm/° C. and thus is significantly sensitive to temperature changes. On the other hand, a light source formed of an erbium-doped filter (EDF) has much lower mean wavelength variation of several tens ppm/® C. with respect to temperature changes, when compared to the semiconductor light source.

As such, an erbium-doped signal light generating apparatus has an improved stability with respect to temperature changes, in comparison to a semiconductor light source. However, suppression of temperature dependence to greater amounts is required in order to enhance the measurement accuracy of a fiber gyroscope.

### SUMMARY

Accordingly, in one aspect, there is provided an erbium-doped signal light generating apparatus which stabilizes a mean wavelength.

According to an aspect, there is provided A signal light generating apparatus including an optical fiber which is a gain medium, a light source to emit pump light, a stabilizing unit to compensate for changes of a mean wavelength of the signal light with respect to temperature change in the optical fiber and to thereby stabilize the mean wavelength of the signal light, and an optical coupler to transmit the pump light from the light source to the optical fiber and to output signal light returning from the optical fiber and signal light returning from the optical fiber via the stabilizing unit by which the signal light is stabilized.

The stabilizing unit may compensate for the changes of the mean wavelength of the signal light by introducing a change of a mean wavelength with respect to temperature changing with a length of the optical fiber to the changes with respect to temperature. Also, the optical fiber may have a thermal coefficient which is a positive (+) value and the stabilizing unit may have a thermal coefficient which is a negative (−) value, wherein the thermal coefficient indicates a correlation between change of the mean wavelength of the signal light with respect to temperature.

The stabilizing unit may be a high-birefringence optical fiber, and specifically, the high-birefringence optical fiber may be a polarization-maintaining optical fiber. In addition, the optical fiber may be an optical fiber doped with a rare earth element, and specifically, the optical fiber may be an erbium-doped fiber.

The stabilizing unit may be provided between the optical coupler and the optical fiber.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a diagram illustrating a configuration of an exemplary signal light generating apparatus.

FIG. 2 is a graph illustrating how thermal coefficient changes with respect to length of an optical fiber.

FIG. 3 is a graph illustrating wavelength change with respect to temperature in the stabilizing unit in FIG. 1.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves those of ordinary skill in the art. Descriptions of well-known functions and structures are omitted to enhance clarity and conciseness.

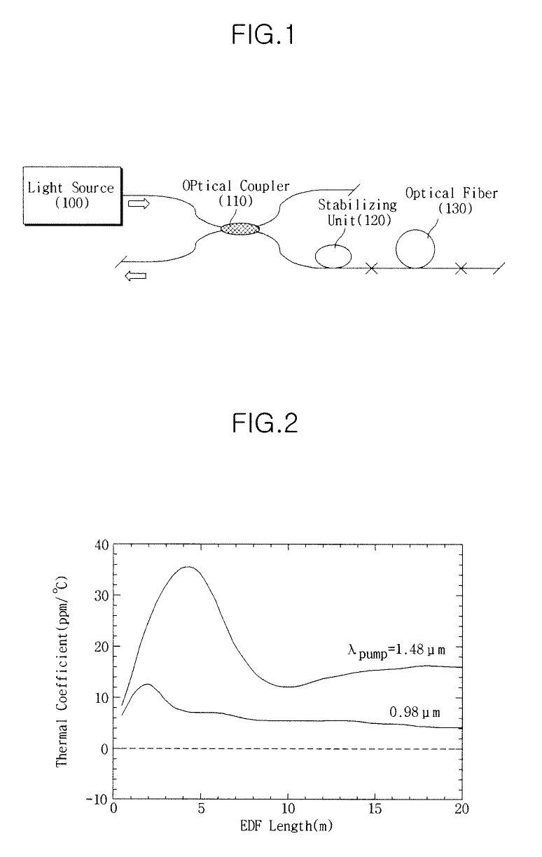

FIG. 1 is a diagram illustrating a configuration of an exemplary signal light generating apparatus. As shown in FIG. 1, the signal light generating apparatus includes a light source 100, an optical coupler 110, a stabilizing unit 120, and an optical fiber 130.

The light source 100 is a pump light source that emits a pump light. For example, the pump light source may be a pump laser diode. The light source 100 has lower pumping efficiency in pump wavelength bands other than a pump wavelength band of 960 to 1000 nm (briefly, 0.98 μm band) and a pump wavelength band of 1440 to 1550 nm (briefly, 1.48 μm) due to an excited state absorption (ESA) phenomenon. Thus, a pump wavelength band of a signal light provided from the optical fiber to the light source 100 may be 0.98 μm band or 1.48 μm, and have a corresponding mean wavelength λ.

The optical coupler 110 may be a wavelength division multiplexing (WDM) coupler. The optical fiber 130 is doped with a rare earth element. For example, the optical fiber 130 may be implemented as an erbium-doped fiber (EDF). The erbium-doped optical fiber has an optical gain in 1.55 μm wavelength band which is the lowest loss band of the optical fiber 130 due to a transition of energy levels between ⁴I_{13/2} and ⁴I_{15/2} of an ion Er³⁺, which is an element of the rare-earth group.

In one example, a pump light emitted from the light source 100 is incident to the optical fiber 130 through the optical coupler 110. Spontaneous emission light is generated in the optical fiber 130, amplified while traveling along the optical fiber, and is emitted as amplified spontaneous emission (ASE) from each end of the optical fiber 130.

In practice, an absorption/emission cross-section of the optical fiber 130 and a mean wavelength of signal light change with temperature. Configuration and operation requirements of a signal light source may affect the characteristics of change of a mean wavelength with temperature.

The stabilizing unit 120 compensates for change of a mean wavelength with temperature in the optical fiber 130. The stabilizing unit 120 is implemented between the optical coupler 110 and the light fiber 130 as shown in FIG. 1.

If the optical fiber 130 has a positive (+) thermal coefficient, the stabilizing unit 120 may be implemented to have a negative (−) thermal coefficient, wherein thermal coefficient indicates a correlation of change of a mean wavelength of the signal light with respect to temperature. Accordingly, the change of a mean wavelength generated in the optical fiber 130 can be compensated for by the stabilizing unit 120.

The stabilizing unit 120 may be implemented as a nonlinear high-birefringence optical fiber. The nonlinear high-birefringence optical fiber can be configured in various forms. Also, a birefringence value of the nonlinear high-birefringence optical fiber will vary dependant on the configuration. In the nonlinear high-birefringence optical fiber, birefringence decreases with the increase of temperature. Therefore, as the temperature increases, a mean wavelength of inner signal light is shifted toward shorter wavelengths, so that the change of a mean wavelength with respect to temperature results in a negative (−) value. In particular, a PANDA type optical fiber has the greatest thermal coefficient. A general polarization-maintaining fiber which is a nonlinear high-birefringence optical fiber may include two or more different materials having different temperature expansion coefficients. Hence, a traveling wave experiences a change of polarization when the temperature changes, and therefore the light source is significantly affected by temperature change.

FIG. 2 is a graph illustrating how thermal coefficient changes with respect to a length of an optical fiber.

As shown in FIG. 2, thermal coefficients change in all of two pump wavelength bands of 0.9 μm and 1.48 μm according to the length of EDF, i.e., the optical fiber 130. Here, the thermal coefficient indicates of the correlation in change of a mean wavelength with respect to temperature. More specifically, when the optical fiber 130 is short, the thermal coefficient is more than 10 ppm/, and as the length of the optical fiber 130 increases, the thermal coefficient decreases. However, it is unclear by how much the optical fiber 130 should be lengthened for the thermal coefficient to reach 0. Hence, it can be understood that a mean wavelength of the signal light in the optical fiber 130 is highly unstable.

Since light source for navigation ultimately aims for a stability of 1 ppm, the change of a mean wavelength with respect to temperature is required to be more stabilized. As shown in FIG. 2, in the optical fiber 130, all thermal coefficients have positive (+) values with respect to changes of EDF length. In the present embodiment, the stabilizing unit 120 has a characteristic of having a negative (−) thermal coefficient, and based on this characteristic, the stabilizing unit 120 cancels out the change of a mean wavelength with respect to temperature in the optical fiber 130. Thus, overall change of a mean wavelength with respect to temperature can be reduced to zero. Moreover, the stabilizing unit 120 may be implemented to compensate for the change of a mean wavelength, considering a fact that the thermal coefficients of the optical fiber 130 vary with the optical fiber length.

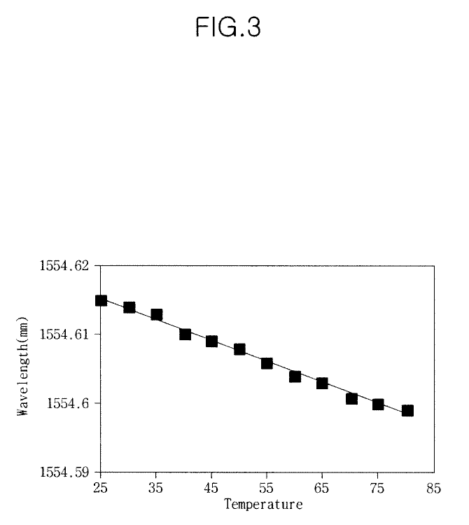

FIG. 3 is a graph illustrating wavelength change with respect to temperature in the stabilizing unit 120 in FIG. 1. As shown in FIG. 3 in the stabilizing unit 120, as temperature increases, the wavelength of the signal light shortens. Thus, a correlation between change of a mean wavelength with respect to temperature is negative.

For example, the stabilizing unit 120 formed as a nonlinear high-birefringence optical fiber may be appropriately provided to a leading end of the optical fiber 130 which has a positive (+) thermal coefficient. Accordingly, it is possible for the stabilizing unit 120 to compensate for the signal light, i.e. ASE, from the optical fiber 130, of which a mean wavelength lengthens as temperature increases, by using the characteristic that a mean wavelength of the signal light shortens as temperature increases in the stabilizing unit 120. In other words, temperature dependence of the signal light can be cancelled out between the optical fiber 130 and the stabilizing unit 120, and thus a mean wavelength of the signal light can be stabilized with respect to temperature change. Therefore, even when the temperature changes, a mean wavelength of signal light in the signal light generating apparatus can be stable.

Also, a signal light generating apparatus may be mounted in a rotation sensing apparatus. Since the signal light generating apparatus for measuring a rotation rate can lower the amount of change of a mean wavelength with respect to temperature and lower a pump power required of a pump light source, temperature dependence can be reduced, and as the stability of the mean wavelength with respect to temperature change is increased, accuracy of rotation rate measurement can be enhanced.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A signal light generating apparatus comprising:
an optical fiber which is a gain medium;
a light source to emit pump light;
a stabilizing unit to compensate for changes of a mean wavelength of the signal light with respect to temperature change in the optical fiber and to thereby stabilize the mean wavelength of the signal light; and
an optical coupler to transmit the pump light from the light source to the optical fiber and to output signal light returning from the optical fiber and signal light returning from the optical fiber via the stabilizing unit by which the signal light is stabilized.

2. The signal light generating apparatus of claim 1, wherein the stabilizing unit compensates for the changes of the mean wavelength of the signal light by introducing a change of a mean wavelength with respect to temperature changing with a length of the optical fiber to the changes with respect to temperature.

3. The signal light generating apparatus of claim 1, wherein the optical fiber has a thermal coefficient which is a positive (+) value and the stabilizing unit has a thermal coefficient which is a negative (−) value, wherein the thermal coefficient indicates a correlation between change of the mean wavelength of the signal light with respect to temperature.

4. The signal light generating apparatus of claim 1, wherein the light source is a pump laser diode.

5. The signal light generating apparatus of claim 1, wherein the stabilizing unit is a high-birefringence optical fiber.

6. The signal light generating apparatus of claim 5, wherein the high-birefringence optical fiber is a polarization-maintaining optical fiber.

7. The signal light generating apparatus of claim 1, wherein the optical fiber is an optical fiber doped with a rare earth element.

8. The signal light generating apparatus of claim 7, wherein the optical fiber is an erbium-doped fiber.

9. The signal light generating apparatus of claim 1, wherein the optical coupler is a wavelength division multiplexing (WDM) coupler.

10. The signal light generating apparatus of claim 1, wherein the stabilizing unit is provided between the optical coupler and the optical fiber.

11. A rotation sensing apparatus comprising:
a signal light generating apparatus including an optical fiber which is a gain medium, a light source to emit pump light, a stabilizing unit to compensate for changes of a mean wavelength of the signal light with respect to temperature change in the optical fiber to thereby stabilize the mean wavelength of the signal light and an optical coupler to transmit pump light from the light source to the optical fiber and to output signal light returning from the optical fiber and signal light returning from optical fiber via the stabilizing unit by which the signal light is stabilized,
wherein the rotation sensing apparatus senses a rotation movement using the signal light output from the signal light generating apparatus.

12. The rotation sensing apparatus of claim 11, wherein the stabilizing unit compensates for the changes of the mean wavelength of the signal light by introducing a change of a mean wavelength with respect to a length of the optical fiber t to the changes with respect to temperature.
